(19) United States
(12) Patent Application Publication
(10) Pub. No.: US 2002/0154647 A1
(43) Pub. Date: Oct. 24, 2002

(54) Frame handler for high-speed fiber optic communication interface

(76) Inventor: Hanan Potash, Austin, TX (US)

Correspondence Address: Hanan Potash, 10403 Charette Cove, Austin, TX, 78759, US

(21) Appl. No.: 09/788,216

(22) Filed: Feb. 16, 2001

(51) Int. Cl. H04L 12/28

(52) U.S. Cl. 370/412; 370/430

(57) ABSTRACT

A method and system are presented for a frame handler, interfacing a SONET communications network to a computer processor. The highly parallel architecture of the frame handler allows it to operate in non-blocking mode—i.e., it can perform add/drop modifications to an incoming frame and begin re-transmission of the frame before the last incoming byte is received. This reduces latency to much less than that of a conventional frame handler, which must buffer the entire frame before re-transmitting it. Furthermore, the cost of the frame handler is reduced, since there is no requirement for large amounts of high-speed memory in which to store the frame. The frame handler is configurable to handle various STS-n frame sizes, and communication protocols.

### BACKGROUND OF THE INVENTION

1. Field of Invention

This invention relates to communications, and more particularly, to a high-speed fiber optic interface for communications.

2. Description of Related Art

In the near future, digital communications networks are expected to undergo tremendous growth and development. As their use becomes more widespread, there is an attendant need for higher bandwidth. To fill this need, present-day copper wire-based systems may gradually be replaced by fiber optic networks. Two key factors enabling this trend will be inexpensive fiber optic links and high-speed distributed protocol processors. The latter are essential in preserving bandwidth while interfacing between dissimilar protocols, such as SONET, Ethernet, Fiber Channel and FireWire.

The SONET (Synchronous Optical NETwork) standard for digital optical transmission was introduced in the late 1980's to provide a means for digitally encoding voice, video and other information for transmission over optical fiber. In a SONET communications network, digital information may be transmitted over an optical fiber by Pulse Code Modulation (PCM) of an optical signal. Analog signals (such as ordinary voice communications) must be digitized prior to being transmitted. For example, an analog telephone signal with a bandwidth of 3.1 KHz is sampled 8000 times per second, quantized and encoded to byte samples and then transmitted at a bit rate of 64 Kbit/s. Because of the enormous bandwidth of the optical carrier, large amounts of information can be conveyed over a single fiber. To fully exploit this bandwidth, it is common to combine digital data from several sources by multiplexing them into a high-speed serial byte stream. The bit stream rate is high enough that the original data may be recovered at the SONET receiver without distortion.

In SONET terminology, communication occurs between nodes. For example, a message may be transmitted from one node and received by other nodes. The basic unit of information exchanged between nodes is a discrete collection of bytes called a frame. A frame always contains a prescribed number of bytes, and comprises manifest and payload portions. The payload represents the actual content, and the manifest (sometimes called the transport overhead, or header) contains frame synchronization bytes, pointers, addresses, and various other information required to recover the data within the payload. The payload portion of the frame is generally a composite of several different types of signals. The constituent signals are merged via Time Division Multiplexing (TDM) into a single payload, and subsequently extracted from the payload at the destination node, using the information contained in the manifest. The so-called “primary rate” (T1 or DS1) used in the U.S., Canada and Japan uses frames consisting of 24 digitized analog voice channels, combined with the necessary signaling information.

SONET networks consist of various types of nodes linked by optical fiber. The simplest nodes are Repeaters, (also known as Regenerators). Repeaters buffer and retransmit incoming frames without altering their content, to overcome signal loss, timing skew, and jitter. Terminal Multiplexers are used to combine multiple input sources into higher-level OC-n signals, or to perform the complementary decomposition of the incoming OC-n into constituent signals. For example, a Terminal Multiplexer may be used to combine three OC-1 inputs into a single OC-3, or to separate a single OC-1 into component DS-1 signals. A special type of multiplexer, known as an Add-Drop Multiplexer (ADM), inserts or removes constituent signals from a SONET frame without affecting the rest of the payload. This, and the fact that the natural topology of fiber optic lines is a ring topology, makes it possible to configure multiple SONET nodes in a ring network.

A SONET network is described in terms of the Open System Integration (OSI) model of layers. The lowest layer is the physical layer, which represents the transmission medium; this is usually a set of fiber links. The next highest layer is the section layer, which is the path between repeaters. A portion of the manifest in each frame (the section overhead) is devoted to the signaling required for this layer. The third layer is the line layer, which refers to the path between multiplexers. The remainder of the manifest (the line overhead) comprises the signaling needed for the line layer. The highest layer is the path layer, which consists of the link of the SONET network from the point where the asynchronous digital signals enter to where these signals exit the SONET network.

The present SONET standard comprises various levels, based on the data rate. The following are the most commonly used:

| | |
|---|---|
| STS-1/OC-1 | 51.84 Mbit/s |
| STS-3/OC-3 | 155.52 Mbit/s |
| STS-12/OC-12 | 622.08 Mbit/s |
| STS-48/OC-48 | 2488.32 Mbit/s |
| STS-192/OC-192 | 9953.28 Mbit/s |

In this family of standards, the “STS-n” nomenclature refers to the “synchronous transport signal” and applies to the electrical signal, while the corresponding “OC-n” nomenclature refers to the associated optical signal. The basic format for all the information conveyed over a SONET network is the STS-1 frame, which consists of 810 bytes. The frames for all the higher levels are derived from combinations of STS-1 frames, either through multiplexing or simple concatenation. For example, an STS-3 frame, which is essentially composed of three STS-1 frames, consists of 2430 bytes. Note that, fundamental to the SONET definition, and enabled by the correspondingly higher bit rates, the frame rate for every STS-n/OC-n level is the same frame rate (preferably, 8000 frames per second.)

An increase in the number of users and a demand for greater bandwidth have resulted in the expansion of fiber optic-based communication networks and the move to higher data transmission rates. In the past, these data rates have been within the capabilities of traditional designs for multiplexers, routers, etc. However, with bit rates as high as 10 Gbit/s, state of the art electronic circuitry is required within the network nodes. Thus, as the trend to higher data rates continues, the SONET electronics will become a limiting factor. Of course, ongoing improvements in semiconductor processing will yield faster transistors, which can extend the capabilities of traditional circuitry. But, as the amount and speed of communications traffic continues to far outpace circuit speed improvements, architectural improvements in the electronic circuitry are fundamentally necessary.

As used herein, the term “frame handler” refers to a type of high-speed communications interface, operating between the fiberoptic backbone ring(s) and the memory of the communications network interface card (NIC) or circuit switching ADM (Add Drop Multiplex) box. The frame handler moves payload traffic to and from the network, and must recognize and interpret any of various communications protocols present on the network. One limitation of common frame handlers is that they are “blocking” nodes. A blocking frame handler must capture an entire frame before it can forward some or all of the payload. This becomes a disadvantage over long paths, where are a large number of blocking nodes are involved in relaying the communications traffic from the sender to the receiver. Assume, for instance, that the communication is a simple telephone conversation. Further assume that the signal must traverse 1000 blocking nodes along the path from the sender to the receiver. As stated above, the SONET frame rate is 8000 frames per second, which implies that there is a 125 μs delay associated with capturing the frame at each blocking node. Since each node must capture the entire frame before it is relayed to the next node, there is a cumulative delay of at least 1000×125 μs, or 125 ms. A delay of this magnitude would be quite audible (and unpleasant) to a human listener. Furthermore, the high-speed memory required to implement a large frame buffer is typically costly.

A further disadvantage of present SONET frame handlers is that they do not support broadcasting, but instead employ a point-to-point multicast method to distribute messages. Thus, in order for a sender connected in a ring to distribute a message to several other nodes within the ring, it is necessary to resend the message to each intended recipient. In view of these disadvantages, it would be desirable to have an efficient mechanism for broadcast communication, instead of only a multi-cast environment.

### SUMMARY OF THE INVENTION

The problems outlined above are in large part solved by a system and method for a frame handler that interfaces a SONET communications network to a computer processor (i.e., optical to wired). According to this system and method, the frame handler operates in non-blocking mode—i.e., it can perform add/drop modifications to an incoming STS-n frame and begin re-transmission of the frame before the last incoming byte of the frame is received. The latency of the frame handler is therefore much less than that of conventional designs, which buffer an entire frame before re-transmitting it. Cost is also reduced, by avoiding the requirement for large amounts of high-speed memory in which to store the frame.

In an embodiment of this system and method, STS-n frames are received and transmitted as a byte data stream. The incoming data stream is parsed “on the fly”, and bytes are added to or removed from the STS-n frame as the data stream passes through the frame handler. This differs from conventionally designed frame handlers, in which the incoming serial data are collected until the entire STS-n frame has been buffered in memory, before parsing the frame.

The architecture of the frame handler is highly parallel and is configurable to handle various STS-n frame sizes (i.e., STS-1, STS-3, STS-12, STS-48, or STS-192), and communication protocols. The frame handler deals with higher-order STS-n frames formed from interleaved lower-order frames (e.g., an STS-3 formed from the interleaved combination of three STS-1 frames). Counters, address pointers, etc. in the frame handler represent the relationship of each incoming byte to the constituent STS-1 frame with which it is associated. Thus, for example, the frame handler internally represents the fact that the 8^{th} byte in an STS-3 frame originated as the 3^{rd} byte in the second of three interleaved STS-1 frames.

The frame handler comprises symmetrical input and output sections, each consisting of a queue manager, pointer control logic, a frame index and an SPE index. The queue manager receives the incoming byte data stream, transfers data between the stream and the memory of the computer processor, and transmits the outgoing byte data stream. In an embodiment of the system and method disclosed herein, the queue manager comprises multiple data capture queues. Each of the data capture queues contains a scrambler/de-scrambler, operating in byte-parallel mode, and a capture table. The capture table contains flag bits, each of which denotes a desired byte within the synchronous payload envelope (SPE). In addition to the multiple data capture queues, the queue manager also contains an overhead capture queue. Analogously to the data capture queues, the overhead capture queue transfers data between the manifest portion of the STS-n frame and the memory of the computer processor. A “set word” instruction programs the queue manager to configure the data port queues according to parameters supplied in the instruction. This instruction includes a broadcast bit, which may be invoked for efficient multi-node distribution of a SONET frame. The broadcast bit induces the queue manager to copy, rather than remove, data from an incoming data stream to be transferred to the memory of the computer processor. When this is done, the frame may be forwarded directly to the next add/drop node in the network, without the sender having to retransmit the frame to each of the intended recipients.

The pointer control logic computes the offset to the start of the SPE within the STS-n frame. Included in the pointer control logic are a set of modulo counters, which compute the STS-1 frame number, and row/column position of each byte in the incoming byte data stream. Also included in the pointer control logic is a frame bias table, which records these offsets. This table may be implemented using two-port random access memory (RAM), and shared between the input and output sections of the frame handler.

The frame index consists of logic to compute the location of the current incoming data byte within the STS-n frame. Similarly, the SPE index computes the logical address of the current incoming byte within the SPE. The system as disclosed herein is amenable to implementation as an integrated circuit.

A method for interfacing a SONET communications network to a computer processor or a circuit-switching box is also contemplated herein. The method includes receiving an STS-n as an incoming serial data byte stream, transferring data from the STS-n frame to the computer processor, modifying the STS-n payload by inserting data from the computer processor, and transmitting the modified payload in an outgoing STS-n byte data stream. According to the method disclosed herein, the first byte of the outgoing payload data stream may be transmitted before the last byte of the incoming payload data stream is received. This amounts to non-blocking operation of the interface, since there is no requirement to buffer the entire received frame before it is re-transmitted.

Note, a new STS-n frame is constructed, by constructing a new manifest (header) and attaching to it the assigned payload at each transmission point. The frame is consumed (destroyed) at each reception point. The payload is passed on to the drop point or passed along to the transmit buffers.

The method further comprises queuing the incoming data stream in input capture queues and queuing the outgoing data stream in output capture queues; the plurality of capture queues accommodates multiple virtual tributaries within the STS-n frame. Overhead capture queues are also provided, for queuing incoming and outgoing data from the manifest portion of the STS-n frame. Incoming data frames are de-scrambled for reception and outgoing data frames are scrambled for transmission, using a scrambler/de-scrambler. The scrambler and de-scrambler operate in byte-parallel mode, since the serial bit rate of a 10 Gigabit transmission typically exceeds the speed of MOS logic gates. The method further comprises using a frame bias table to record the offset to the start of each synchronous payload envelope (SPE) the payload proper within the STS-n frame, and a frame index to record the physical address of each byte in the incoming data stream with respect to the STS-n frame. The method also calls for an SPE index to record the address of each byte in the incoming data stream with respect to the SPE. Furthermore, a capture table is associated with each capture queue; the capture table contains flag bits, each of which corresponds to a desired byte within the SPE.

In addition, the method disclosed herein provides for a set port instruction, which configures the capture queues according to parameters attached to the instruction. A broadcast bit in the set port instruction configures the frame handler for broadcasting. In normal operation, data within the STS-n frame that are transferred to the computer processor are removed from the frame and replaced with a designated “Empty” byte before the frame is re-transmitted by the frame handler. On the other hand, in broadcast mode the data are copied, rather than removed. This is advantageous if there are several intended recipients for the data, since it allows the same frame to be forwarded to the next add/drop node, and avoids the sender having to issue individual copies of the information to each intended recipient.

Note that it may be desirable to assign particular values to the “Empty” byte, depending on the situation. For example, clock regeneration circuitry within the frame handler recovers the data clock rate from logic level transitions in the SONET bit stream. By assigning an alternating bit pattern such as 10101010 (xAA, in hexadecimal notation) to the Empty byte, clock recovery is made easier. On the other hand, the Empty byte may be assigned a pattern of all 0's or all 1's to deliberately stress the clock regeneration circuitry for diagnostic purposes.

For the reasons discussed above, the system and method described herein are believed to offer better performance than existing frame handlers, as well as being significantly less expensive.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### BRIEF DESCRIPTION OF THE DRAWINGS

Other objects and advantages of the invention will become apparent upon reading the following detailed description and upon reference to the accompanying drawings in which:

FIG. 1a shows the structure of a standard STS-1 frame;

FIG. 1b shows the transmit/receive byte order corresponding to the STS-1 frame structure;

FIG. 2 illustrates how a single synchronous payload envelope (SPE) may span consecutive STS-1 frames;

FIG. 3 depicts byte-interleaving, by means of which, 3 STS-1 frames are combined into a single STS-3 frame;

FIG. 4 contains a block diagram of the input section of an embodiment of the SONET frame handler disclosed herein;

FIG. 5 contains a block diagram detailing the internal structure of an embodiment of a capture queue and a parallel-mode X⁴³+1 scrambler/de-scrambler; and

FIG. 6 contains a block diagram of the output section of an embodiment of the SONET frame handler disclosed herein.

### DETAILED DESCRIPTION OF THE PREFERRED EMBODIMENTS

Data communications traffic is increasing at an explosive rate. This is due in part to growth in the number of transactions, as e-commerce and Internet use continue to rise. A second factor has been an increase in the average size of the transactions, in terms of the sheer number of bytes transferred. This is evident as companies make greater use of teleconferencing and individuals routinely retrieve bulky multi-media files from websites. Optical data communications networks may potentially answer the demand for greater bandwidth. Current specifications for optical transport networks allow transmission rates up to almost 1 Gbps (OC-192) on a single optical wavelength. And future developments, such as dense wavelength division multiplexing (DWDM), which can presently transmit 128 wavelengths (colors) and holds forth the possibility of transmitting many more wavelengths (colors) over a single optical fiber, potentially extend this carrying capacity to over 800 Gbps.

To fully exploit this bandwidth, a high-speed interface is needed between the fiber optic channel conveying the data and the electronic data communications equipment for which the data is intended. Obviously, any such interface must comply with operative standards. The prevalent technology for telecommunications “backbones” (i.e., major routes in a communications network) is based on the Synchronous Optical NETwork (SONET) standard.

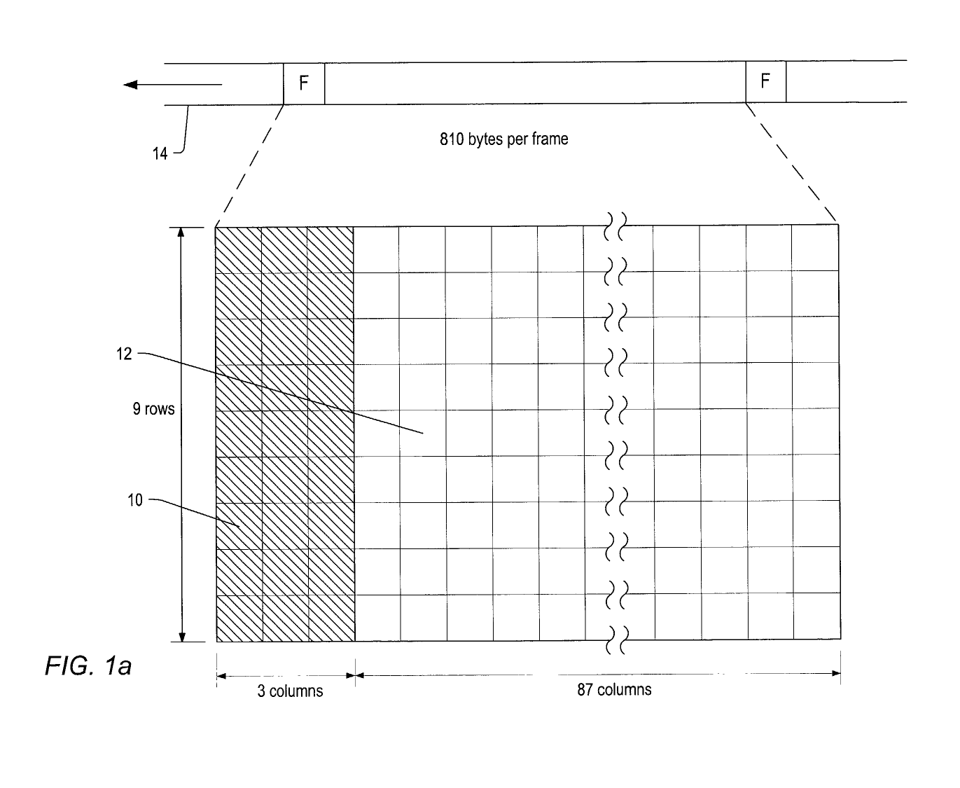

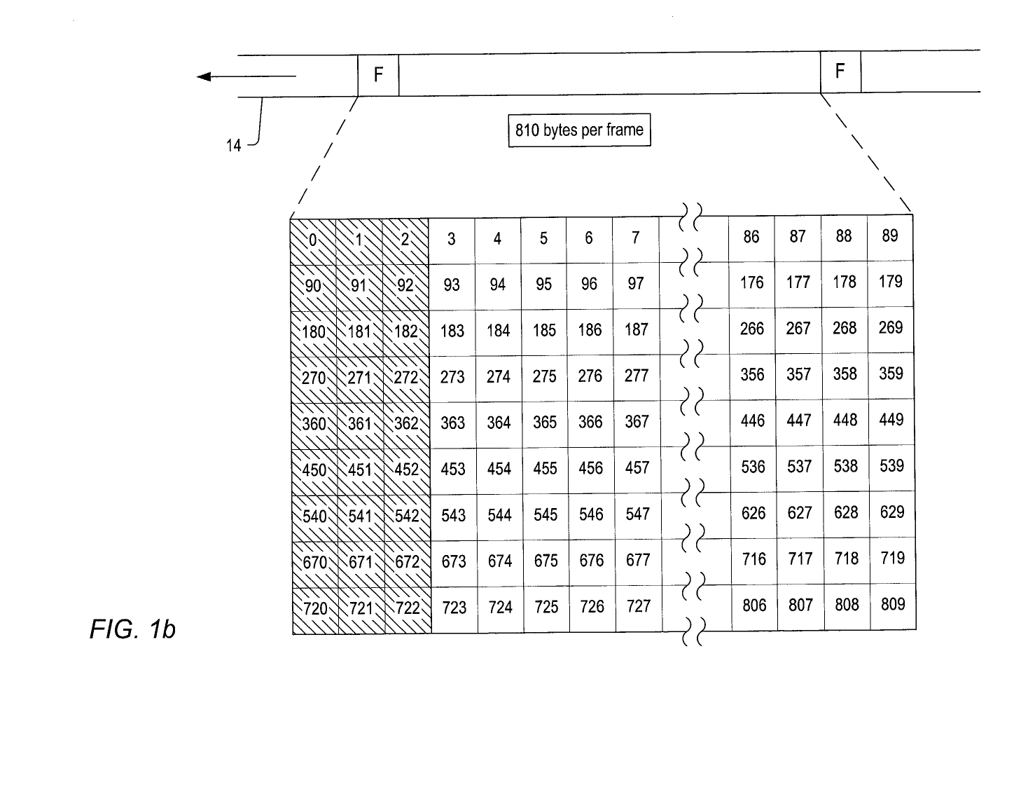

SONET data are transferred in “frames”. The structure of an STS-1 frame, the fundamental unit in SONET, is shown in FIG. 1a. Each frame consists of two parts, a manifest 10 (“manifest—a list of passengers or cargo carried on a plane or a ship” also called the “header,” or “transport overhead”) and a synchronous payload envelope 12 (also known as the “SPE”, or simply, the “payload”). The STS-1 frame is comprised of 810 bytes, organized as 9 rows and 90 columns; the first 3 columns comprise the manifest and the remaining 87 columns comprise the SPE. Frames are transmitted or received as a byte data stream 14. The bytes in the frame are sent row-by-row, from top to bottom, left to right, as shown in FIG. 1b. As described above, each SONET interface (or “node”) contains a clock regeneration circuit, also known as a “phase lock loop”, necessary to properly reconstitute frames from the incoming serial bit stream. Also present is a highly accurate clock, synchronized with a diurnal standard clock used in the running of the chip's processor and generating the outgoing frames. The internal clock is periodically adjusted, so that its average rate is the same as that of the diurnal clock. Obviously, no two SONET nodes can have identical clock frequencies. In fact, their clock frequency will vary slightly over a diurnal period. However, since both nodes are synchronized to the diurnal clock, the total number of pulses issued by both clocks within the diurnal period will be identical within a predetermined margin.

Thus, a SONET node is capable (through periodic checks with the diurnal clock) of adjusting its frequency as necessary to maintain synchronicity acceptable by the upstream node, as well as (through the clock regeneration circuit) accommodating an asynchronous incoming data stream. The nominal SONET frame transmission rate is 8000 frames per second. Therefore, the STS-1 data rate can be computed as:

$$\frac{\text{810 bytes}}{\text{frame}} \times \frac{\text{8 bits}}{\text{byte}} \times \frac{\text{8000 frames}}{\text{second}} = \frac{\text{51.84 Mbits}}{\text{second}}$$

The payload portion of the frame represents the actual content, and the manifest contains frame synchronization bytes, pointers, and various other information required to recover the data within the payload.

Although the SONET frames themselves are transmitted synchronously, they may be used to transport data that is received isochronously with the frame generation. The term isochronous refers to a process in which data must be delivered within certain time constraints. For example, multimedia streams require an isochronous transport mechanism to ensure that data is delivered as fast as it is displayed and to ensure that the audio is synchronized with the video. Isochronous may be contrasted with asynchronous, which applies to processes in which data streams may be broken by random intervals, and synchronous processes, in which data streams can be delivered only at specific intervals. Thus, isochronous service is not as rigid as synchronous service, but not as lenient as asynchronous service. Isochronous data is often thought of as streaming data. Isochronous data is typically sent in real time without delays therein so that the data can also be played in real time. Isochronous data is therefore data that is sent in a regular, periodic and continuous fashion. Whereas, non-isochronous data is data that can be sent in bursts. It is therefore not important that non-isochronous data be sent in a continuous, periodic fashion.

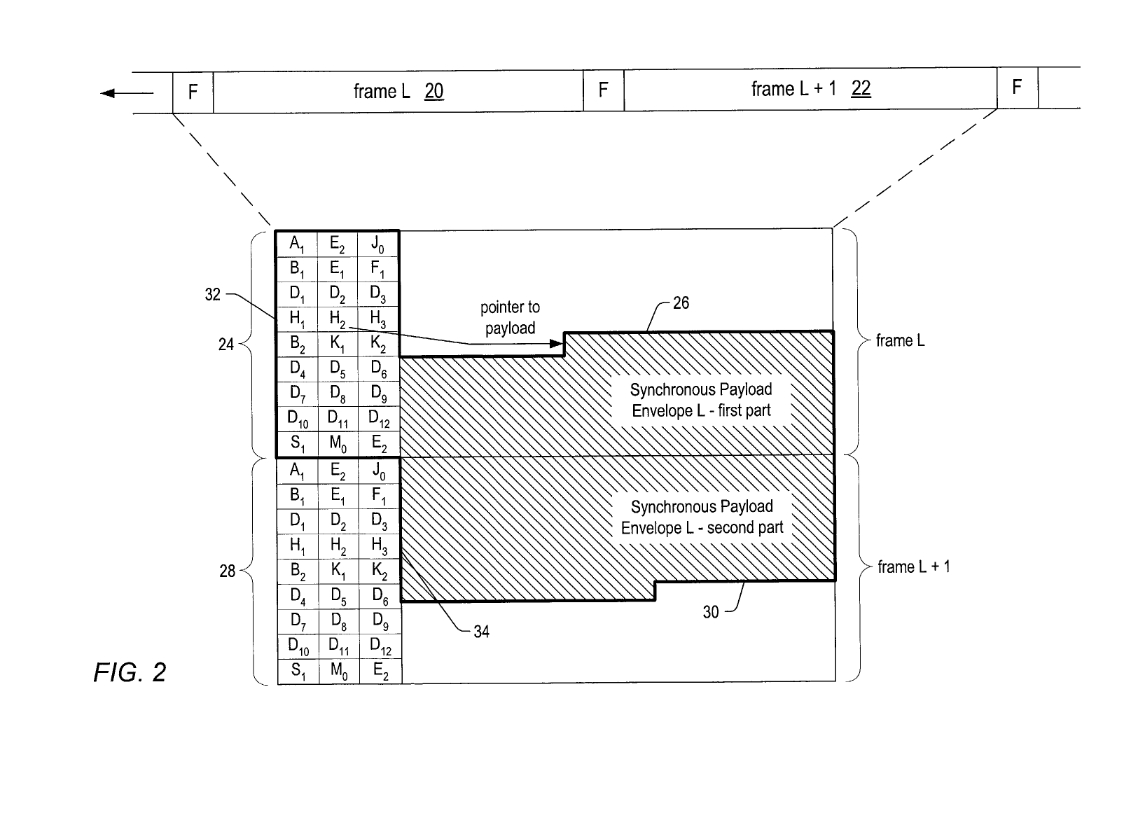

The isochronous timing of SONET data may be understood through an analogy in which the SONET frame is represented by a bus that always departs on schedule, and the data by passengers who arrive at various times to board the bus. The bus leaves at its prescribed departure time, whether or not it is full, carrying however many passengers have boarded the bus in time. Passengers arriving too late to board the first bus must board the next one. In a similar fashion, isochronous data are incorporated into the synchronous SONET frame format. To accommodate the isochronous data, the payload is allowed to begin anywhere within the designated SPE portion of the frame, and will span to the next consecutive frame. This is illustrated in FIG. 2, where two consecutive frames 20 and 22 are used to transmit the first 26 and second 30 halves of a payload. The manifest 24 for frame L is comprised of bytes used for synchronization, status, parity, etc., for the SPE frame L whose first part is in STS frame L and second part in STS frame L+1. The two halves of the payload and the associated manifest are contained within the heavy outline in FIG. 2.

Two bytes within the manifest, H₁ and H₂ 32, constitute the payload pointer in frame L. Bytes H₁ and H₂ form a binary number from 0 to 782, indicating the starting position of the payload envelope (SPE) within the STS frame. The payload spans two consecutive frames, as shown in FIG. 2, and byte H₃ 34 becomes a “pointer action” byte, used to adjust pointer values in response to the effects of phase and frequency differences between the data and the frame. Because the incoming data are isosynchronous with respect to the timing of the STS-1 frame, it may happen that the starting position of the payload must be adjusted. For example, if the data clock is advancing in phase (running slightly faster) with respect to the frame clock, eventually the data will arrive “too early”. This is dealt with by stuffing an incoming data byte into the H₃ byte position 34 in manifest 28 of frame L+1, effectively advancing the frame timing. In a subsequent frame, the payload pointer 32 is adjusted (i.e., decremented) to “catch up” with the data. This mechanism allows SONET frame timing to dynamically adapt to phase and frequency changes in the data stream, and to the effects of variations in node-to-node timing.

Note that, a SONET node can begin to relay a payload after acquiring data from the first SPE, rather than having to wait until the entire SPE payload has been received. This greatly expedites the transfer of data from node to node in a SONET network.

The SONET standard allows for dynamic bandwidth allocation, to accommodate “bursty” communications traffic, with a very high peak-to-average bandwidth requirement. SONET specifies the following rate hierarchy:

| | |
|---|---|
| STS-1/OC-1 | 51.84 Mbit/s |
| STS-3/OC-3 | 155.52 Mbit/s |
| STS-12/OC-12 | 622.08 Mbit/s |
| STS-48/OC-48 | 2488.32 Mbit/s |
| STS-192/OC-192 | 9953.28 Mbit/s |

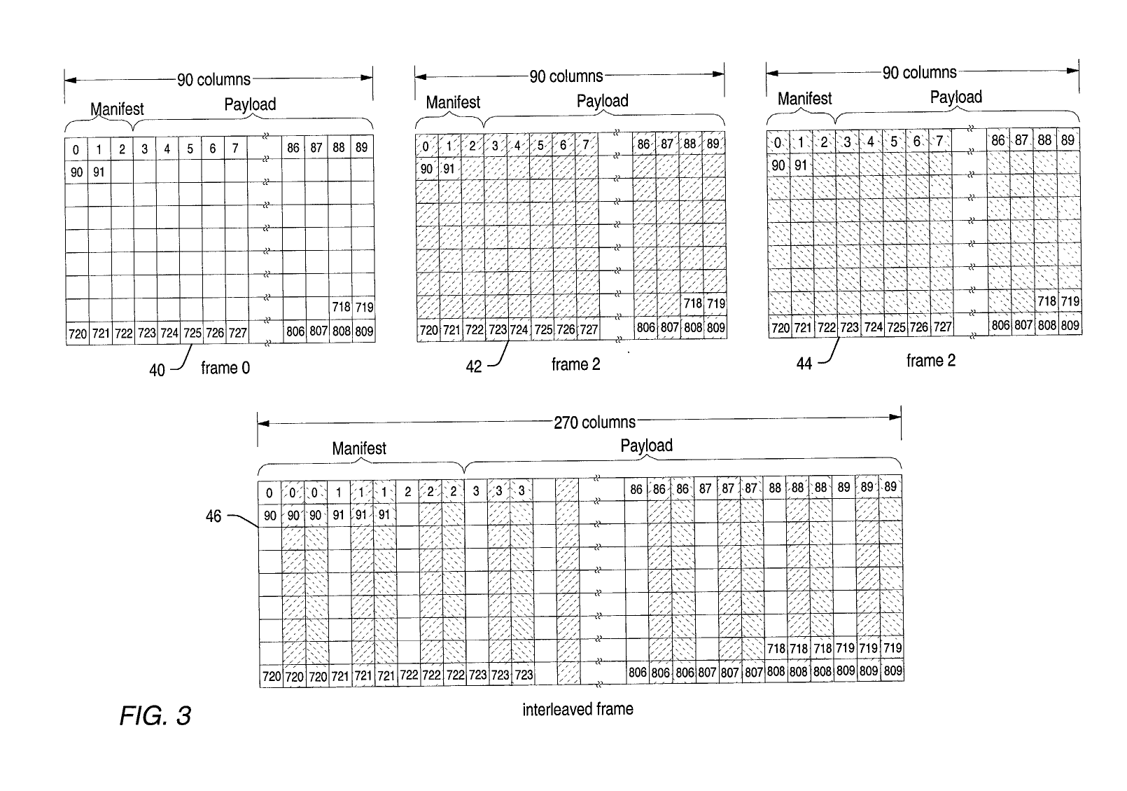

Conveniently, frames at lower transmission speeds can be multiplexed into higher rate frames, by a technique known as “byte-interleaved multiplexing”. Thus, for example, three STS-1 frames can be combined into an STS-3 frame with no loss of data. This technique is illustrated in FIG. 3.

In FIG. 3, three STS-1 frames are merged, using byte-interleaved multiplexing, into a single STS-3 frame. As described above, an STS-1 frame is organized as 9 rows×90 columns, with the first 3 columns of the frame containing the manifest, and the other 87 columns the payload. An STS-3 frame has exactly three times the number of bytes as an STS-1 frame. Thus, the manifest of an STS-3 frame spans 9 byte columns, and its payload 261 columns. Byte-interleaved multiplexing populates the STS-3 frame by taking bytes from each of the three STS-1 frames in turn, preserving the order in which they occur in the STS-1 frame. In FIG. 3, the three constituent frames, 40, 42 and 44, are distinguished by a hatch pattern (i.e., no hatch, right-leaning hatch and left-leaning hatch). Also note that some of the bytes in all three STS-1 frames are numbered. The resultant STS-3 frame 46 retains these hatch patterns and byte numbering to indicate how the bytes from the three constituent frames are distributed. Referring to the upper left corner of STS-3 frame 46, for example, it can be seen that the first byte in STS-3 frame 46 is taken from the first byte in STS-1 frame 40, the second from the first byte in STS-1 frame 42, and the third from STS-1 frame 44. Similarly, the fourth byte in STS-3 frame 46 is taken from the second byte in STS-1 frame 40, the fifth byte from the second byte in STS-1 frame 42, etc. Note that, since the STS-3 frame rate is the same as that for the STS-1 frames (i.e., 8000 frames per second), the bit (and thus byte) rate is three times higher:

$$\frac{\text{3} \times \text{810 bytes}}{\text{frame}} \times \frac{\text{8 bits}}{\text{byte}} \times \frac{\text{8000 frames}}{\text{second}} = \frac{\text{155.52 Mbits}}{\text{second}}$$

“Bursty” communications traffic is characterized by a moderate average bit rate, with occasional high bit rates. It can be seen that byte-interleaved multiplexing can provide a means whereby a transitory demand for greater bandwidth can be satisfied, by formatting the incoming data into higher-order frames, thereby increasing the transmission rate.

SONET-compliant data transmission networks are often called upon to transmit asynchronous data formats, such as DS1 (with a capacity for 24 digitized voice-grade telephone signals) or ATM (“asynchronous transfer mode”, in which small fixed-size “cells” are used to transmit video, audio and computer data at up to 622 Mbps). SONET supports the embedding of data structures within the STS-X frame, through the use of “virtual tributaries”. There are four types of virtual tributaries specified for SONET multiplexing: VT 1.5, VT 2, VT 3 and VT 6. Within the payload of the SONET frame, each of these is organized into a virtual tributary group (VT-G). The VT-G's are transmitted as 6.912 Mbps signals, seven of which can be multiplexed into an STS-1 frame. As an example, the VT 1.5 tributary carries 1.544 Mbps DS-1 signals, and four VT 1.5's form a VT-G. Therefore, 28 VT 1.5 virtual tributaries can be encapsulated in a single STS-1 frame. Since each DS-1 represents 24 digitized voice-grade telephone channels, a total of 672 standard voice channels may be multiplexed into a single STS-1 frame.

A “frame handler” is a part of a SONET node situated between the fiber optic backbone and the communications network interface card (NIC) in a computer or a communication switch. The frame handler moves data to and from the SONET network, recognizes the beginning of an incoming frame, interprets the incoming manifest and constructs the outgoing frame and manifest according to the SONET communications network protocols. At higher data communication rates the frame handler must process frames as expeditiously as possible, and with bit rates approaching 10 Gbps (for STS-192) the capabilities of conventional frame handlers may be strained. The options for increasing frame handler throughput are limited. One approach is simply to rely on advances in semiconductor technology to improve the performance of existing designs, by increasing the operating speed of the individual components. However, progress in this area is difficult to predict, and it is uncertain whether faster devices will appear soon enough to be practical. A second approach is to design the frame handler so that frame-processing operations are shared by multiple conventional processors, working in parallel to enhance throughput. Here again, the processor architecture does not change—we merely allocate more processors to the task. This strategy is made viable by the fact that the entire frame-processing task is readily subdivided into independent sub-tasks. Unfortunately, since this approach effectively multiplies the circuitry within the frame handler, it will add considerably to its cost.

The third approach to achieving higher bandwidth in the frame handler is to improve its basic design, making it inherently faster. This approach avoids dependence on yet to be developed semiconductor technology, and offers performance gains at a lower cost than highly parallel architectures. Among the advantages of the novel frame handler architecture disclosed herein are that it is “non-blocking”.

Common frame handlers suffer from the disadvantage that they are “blocking” nodes—i.e., they must capture an entire frame to internal memory before they can distribute the payload. This incurs a delay of

$$\frac{1}{8000} = 125 µs$$

per node. Over a long path, where the communications traffic must propagate through thousands of blocking nodes, the cumulative delay may become intolerable. In addition, the frame buffers used in blocking frame handlers require large amounts of high-speed memory, which tends to make them expensive. In contrast, the frame handler architecture disclosed herein allows incoming data to be distributed before the entire frame is received (as described in more detail below). This substantially reduces the propagation delay through the frame handler, compared to a blocking node, and would be particularly advantageous for long, multi-node communication paths.

A further disadvantage of present SONET frame handlers is that they do not support “broadcasting,” but instead employ a point-to-point multicast method to distribute messages. This is analogous to the way e-mail is distributed to a list of recipients. Instead of relaying the e-mail message from one recipient to the next, the mail server generally has to resend the mail to each recipient. A similar situation applies for a conventional frame handler in a SONET network configured as a ring. To distribute a message to several other nodes within the ring, it is necessary to resend the message to each intended recipient. In contrast, the frame handler architecture disclosed herein supports broadcasting. In this case, as the message is distributed to nodes along the ring, each node copies the message and passes it on. This avoids the need for the node acting as the message server to repeatedly resend the message.

As discussed earlier, SONET networks consist of various types of nodes linked by optical fiber. An Add-Drop Multiplexer (ADM) node inserts or removes constituent signals from a SONET frame without affecting the rest of the frame, thus permitting multiple ADM nodes to be configured in a ring network. The frame handler architecture disclosed herein represents a type of ADM node. In an embodiment described herein, the frame handler provides 16 input and 16 output data ports for conveying payload traffic to and from the fiber optic network. A 17^{th} channel is also provided, for the transfer of manifest information.

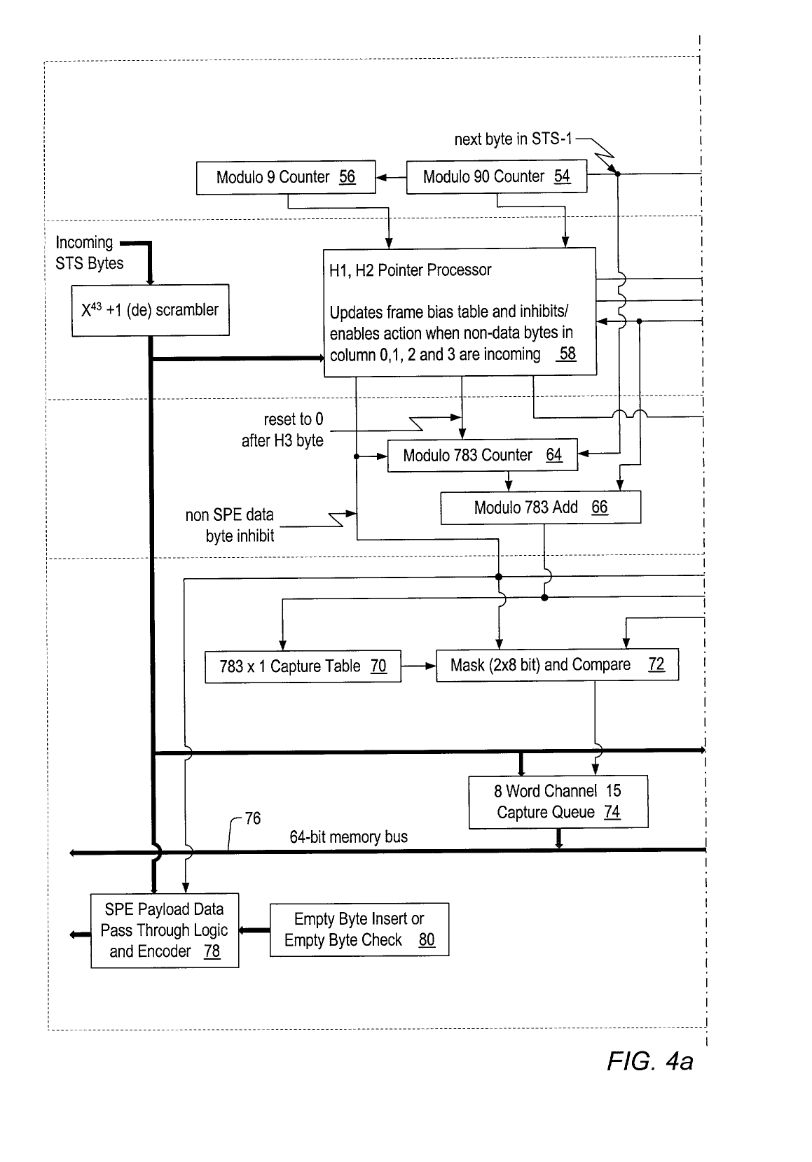

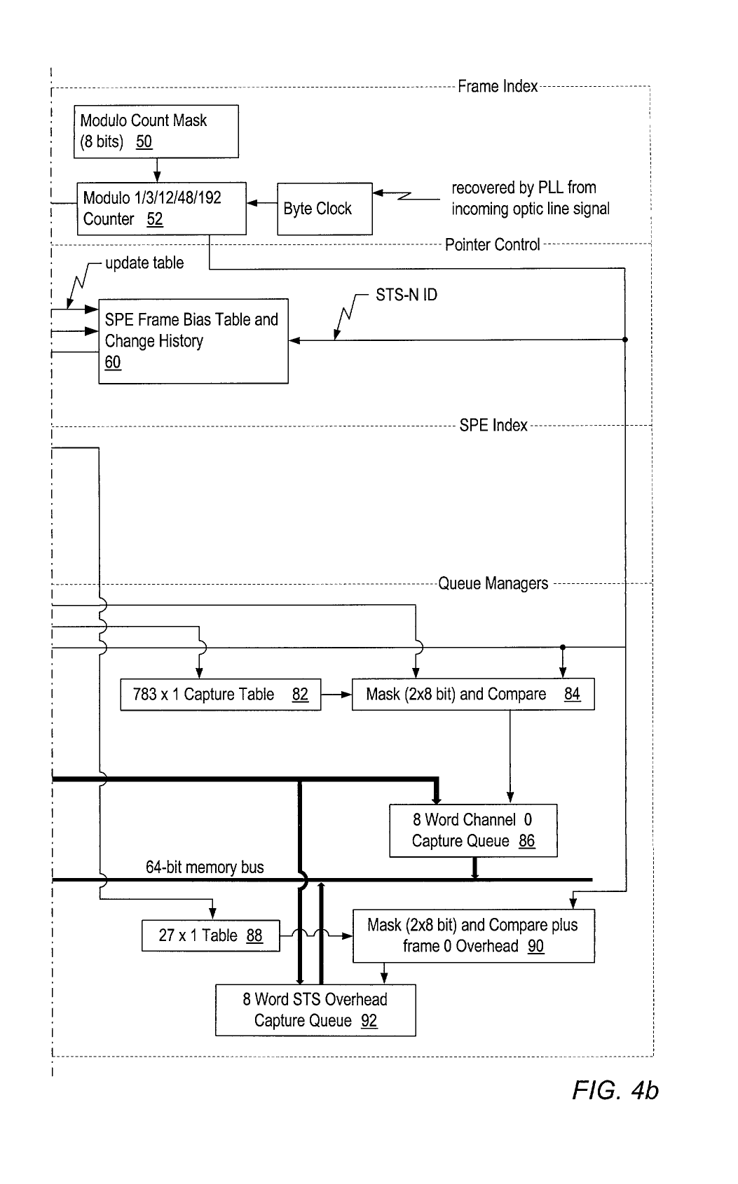

In an embodiment disclosed herein, the frame handler architecture comprises four segments: the Frame Index, the Pointer Control, the SPE Index and the Queue Managers. FIG. 4 contains a block diagram of the input section of an embodiment of the frame handler. The following discussion refers to FIG. 4, and explains the operation of each of these segments.

The Frame Index segment of the frame handler comprises the components enclosed within the top-most rectangular region in FIG. 4. This circuitry generates the physical address of each incoming byte in the received STS-n SONET frame. (A similar circuit in the output section of the frame handler, discussed below, performs this function for the bytes in outgoing frames.) The Frame Index is programmed to operate in one of the standard OC modes (OC-1, OC-3, OC-12, OC-48, or OC-192), using the 8-bit count mask 50. This mask sets the modulus of modulo-1/3/12/48/192 counter 52 to 1, 3, 12, 48, or 192. The Frame Index is synchronized to the incoming data stream by reference to the binary pattern contained in the first two bytes (A₁ and A₂ in FIG. 2) in the manifest of the SONET frame. A byte stream containing the specific bit pattern A₁=11110110 and A₂=00101000 (or, A₁=x-F6 and A₂=x-28, in hexadecimal notation) is used to establish synchronization. This byte stream precedes the frame, and the Frame Index counts consecutive occurrences of this bit pattern in preparation to receive the incoming frame. For example, synchronization with an incoming OC-48 frame is achieved after the Frame Index recognizes a stream of 48 consecutive occurrences of xF6 followed by 48 consecutive occurrences of x28. Following the first two bytes of the manifest (A1 and A2) in the first frame received after the Frame Index has achieved synchronization, the modulo-1/3/12/48/192 counter 52 is set to 0, modulo-90 counter 54 is set to 2, and modulo-9 counter 56 is set to 0. From this point, these three counters keep track of the location of the current byte within the STS-n frame. As incoming bytes from the SONET data stream are received, modulo-1/3/12/48/192 counter 52 indicates the STS-n frame number.

Recall from the earlier discussion of byte-interleaved multiplexing that an STS-n frame comprises bytes from N STS-1 frames. Given the position of a byte within the STS-n frame, it is possible to determine which STS-1 frame the byte was taken from, as well as its position within the STS-1 frame.

m(modn)=STS-1 frame from which byte m in STS-n frame was taken

$$int ( \frac{m}{n} ) = \text{position in original STS-1 frame of byte} \text{m} \text{in STS-n frame}$$

=position in original STS-1 frame of byte m in STS-n frame Assume for example, that we have an STS-48 frame, and we want to know which of the 48 constituent STS-1 frames byte 273 originally came from. To do this, we use the first expression above to calculate 273(mod 48)=33. To determine the location of byte 273 within STS-1 frame 33, we use the second expression above to calculate int(273/48)=5. These arithmetic relationships allow simple logic circuits in the Frame Index to keep track of the original STS-1 frame, column and row for the current byte. In particular, the modulo-1/3/12/48/192 counter 52 effectively performs the above calculations on the bytes incoming STS-n frame. By definition, a modulo-N counter counts events from 0 to N-1, and then “rolls over”—i.e., it resets to 0 and continues counting. At any time, the current value held in the counter may be read. Furthermore, the counter issues an output pulse when it rolls over. Assume counter 52 is configured as a modulo-48 counter, and that it counts incoming bytes from an STS-48 frame. At any point, the count held in counter 52 represents the STS-1 frame from which the current byte originated—this is the value given by the first expression above. Every 48^{th} byte causes the counter to roll over, transmitting an overflow pulse to modulo-90 counter 54. The number of overflow pulses issued by the modulo-48 counter 52 is equivalent to the second expression above. Referring to the previous example, by the time byte 273 was received, modulo-48 counter 52 would have rolled over (and clocked modulo-90 counter 54) 5 times, and would hold a count of 33. This correctly indicates that byte 273 was originally byte 5 in STS-1 frame 33.

Thus, in composite frames, such as STS-3, STS-12, STS-48, and STS-192, modulo-1/3/12/48/192 counter 52 indicates which constituent STS-1 frame the current byte is associated with. Within a given STS-1 frame, modulo-90 counter 54 indicates the column and modulo-9 counter 56 indicates the row of the current byte. Modulo-113/12/48/192 counter 52 is incremented by byte clock 94 each time another byte is received by the frame handler. Modulo-90 counter 54 is incremented when the modulo-1/3112/48/192, for example, when counter 52 reaches a count of 47, for an STS-48 frame. This is consistent with the standard sequence for byte interleaving (as described in connection with FIG. 3), in which successive bytes are taken from the same column in each of the constituent STS-1 frames, before starting the next column. Similarly, modulo-9 counter 56 is incremented each time modulo-90 counter 54 reaches 89.

The Pointer Control segment of the frame handler maintains the logical addresses of the N SPEs within the STS-n physical frame. It will be recalled that the SPE is the 783 byte “payload” portion of an 810 byte STS-1 frame, and that an SPE will typically span two consecutive STS-1 frames. The H₁H₂ pointer processor 58 is responsible for maintaining the offset to the SPE within the STS-n frame. These offsets are updated by the H₁H₂ pointer processor 58 and stored in SPE frame bias table and change history 60. The frame bias table maintains up to 192 pointers (for an STS-192 frame). The frame bias change history is used when the SPE bias is changed. A new bias coming from the H₁H₂ pointer processor 58 must remain valid for three consecutive 125 μs frame cycles before it is entered into the bias table 60. Note therefore, that an OC-48 contains 48 independent individual SPEs, each with its own bias with respect to the main OC-48 frame. A frame bias table also exists in the output section of the frame handler (discussed below), to keep track of the SPE bias in outgoing STS-n frames. The two tables may be individually or jointly implemented using a 256 entry two-port RAM. In this case, the read port of the two-port RAM is addressed by the modulo-1/3/12/48/192 counter 52, and the address counter for the write port of the two-port RAM is used to update the H₁H₂ pointer processor in the output section.

The SPE Index portion of the frame handler generates the logical address of the current byte within the SPE payload. This address is valid only when the current byte is actually a payload byte—otherwise, a “non SPE data byte inhibit” line is activated, to indicate that the current byte is part of the manifest. The modulo-783 counter 64 indicates the physical address of the current byte within the STS frame. This address could be derived from the values in the modulo-90 counter 54 and the modulo-9 counter 56, but it is simpler to compute it independently. The modulo-783 counter 64 is initialized to 0 when modulo-112/12/48/192 counter 52, modulo-90 counter 54 and modulo-9 counter 56 are initialized to 0, 2, and 0, respectively. This corresponds to the address of byte H₃ in the first STS-n frame (see FIG. 2). Once it is initialized, modulo-783 counter 64 remains synchronized with modulo-90 counter 54 and modulo-9 counter 56, and counts every incoming byte, unless inhibited by the “non SPE data byte inhibit” line. The logical address of a payload byte is derived from its physical address in the SPE by modulo-783 adder 66, which adds the to the physical address the SPE bias from SPE frame bias table 60.

The Queue Managers segment of the frame handler comprises the following functional portions, each of which is discussed below:

(1) 16 payload port queues

(2) a port queue for frame manifest information

(3) the SPE payload pass-through logic

Each of the 16 payload port queues comprises an 8-word (64-bit words) capture queue 74 and 86, containing an X⁴³+1 scrambler/de-scrambler. Scrambling transforms any bit sequence into one with enough logic level transitions to enable clock recovery.

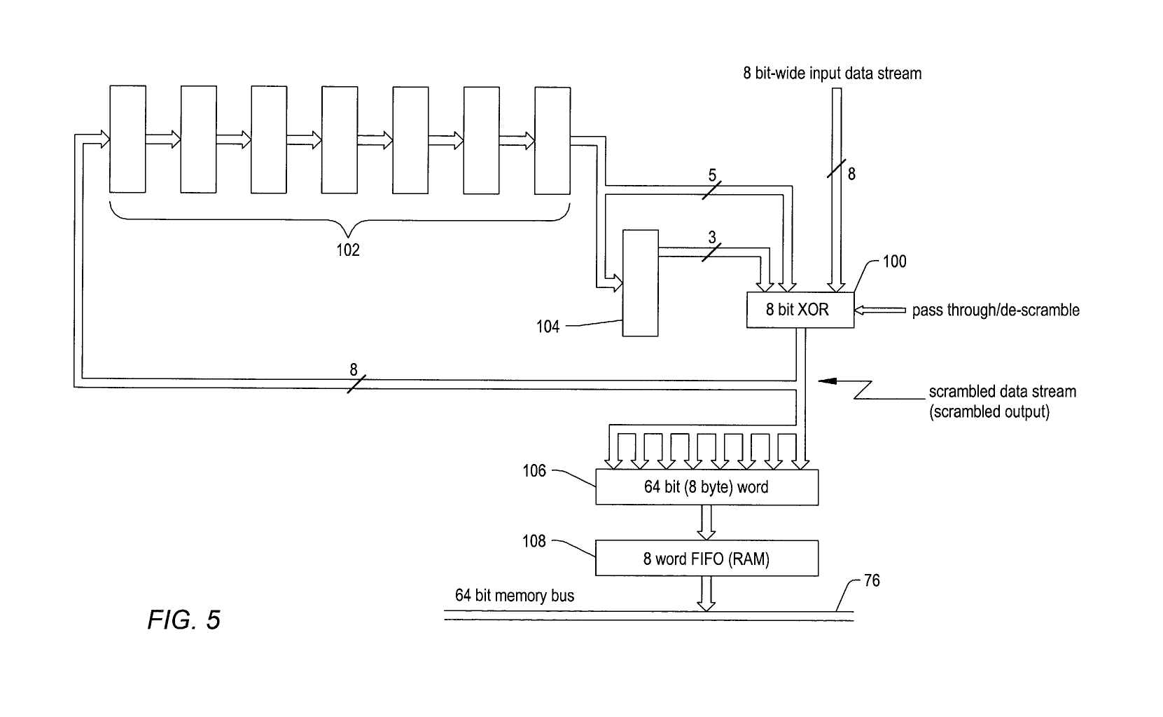

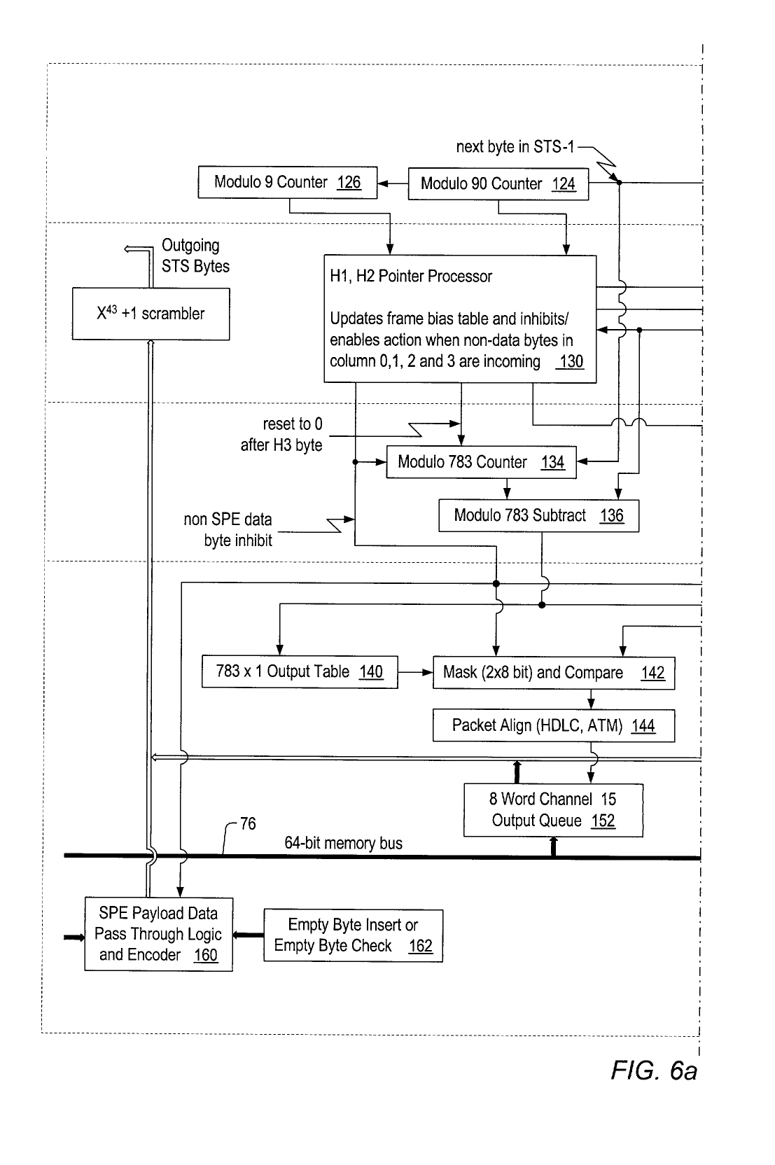

FIG. 5 shows the internal structure of the capture queues, along with the X⁴³+1 scrambler/de-scrambler. Incoming bytes are received by high-speed XOR circuit 100 over an 8-bit data bus. Each byte received is XORed with an 8-bit value derived from previous bytes by passing them through a series of 8-bit registers 102 and 104. Note that, in contrast to conventional serial scrambler designs, this scrambler performs the scrambling operations “byte-wise.” This greatly enhances the speed with which the scrambler can process incoming data.

Referring again to FIG. 4, in addition to the capture queue 74 and 76, each payload port also contains a 16-bit mask and compare word 72 and 84, and a 783-bit capture table 70 and 82. The upper 8 bits of the mask and compare word are a mask, using which, the address formed by the lower 8 bits is compared against the STS-n ID from modulo-1/3/12/481192 counter 52. The 783-bit capture table 70 and 82 contains a logic 1 for every byte in the SPE frame. A match on the STS frame and the bit in the SPE queue table will move the incoming byte to the input buffer. A similar match in the output section of the frame handler moves a byte from the output buffer to the outgoing data stream. A match is detected using a frame-under-mask selection, given a desired virtual channel within the frame. The frame-under-mask compares the “Modulo 1/3/12/48/192” frame location against the desired virtual channel. For example, if one is receiving a full STS-1 (say, STS-1 number 17) out of an STS-192, the compare will be binary 00010001, the mask all 0's, and the 783 bit table all 1's. If, instead of the entire virtual channel, one wanted just a single DS0 (i.e., one telephone line out of the STS-1), the table would contain only a single 1 among the 783 entries.

The payload port queue is set up by a set port instruction, containing the following parameters:

(a) A 16-bit word containing the STS ID and STS I) mask. If this mask is all 1's, the payload port queue logic selects a single STS out of an STS-n. For example, an individual STS-1 might be selected out of the 48 STS-1 frames interleaved into an STS-48.

(b) A table of 15 64-bit words, containing the 783-bit STE capture bit map. This bit map is used to select specific bytes within the STE frame corresponding to virtual tributaries, or in the case of ATM or traffic, to protocol-specific structure within the SPE.

(c) A 32-bit starting address of the data destination.

(d) A 32-bit size of the data destination table.

(e) A 32-bit word containing the number of bytes in the incoming record.

(f) A 32-bit multiplexing index for the destination table. The multiplexing index separates consecutively written (or read) words in memory, to facilitate their subsequent formatting into constituent STS-1 channels. For example, an STS-48 is comprised of 48 STS-1 channels. Placing the incoming data 48 words apart allows for later reformatting of the data into 48 tables, with each table containing the consecutive data from an STS-1 SPE frame.

(g) A format word, portions of which include 3-bits defining the number of bytes per word, a left/right justification flag for partial word fill, a 32/64-bit word flag, a broadcast bit, etc.

The port queue for frame manifest information 92 is similar to the data port queues, and is accompanied by a 16-bit mask and compare word 90 and a capture table 88. There are two significant differences between these components and their counterparts in the data port queues:

(a) The table 88 contains 27 entries and is directed by the H₁H₂ pointer control section 58, based on modulo-90 54 and modulo-9 counters 56.

(b) The format word in the corresponding set port instruction contains an additional 2-bit manifest entry. The first bit indicates that the table is to be ignored during the first SONET frame. The second bit indicates that the Ml byte, rather than the H₃ byte, should be captured on the last frame.

The SPE payload pass-through logic 78 comprises a 1 Kbyte or higher size buffer, which functions as an interface and rate matching circuit between the input and output sections of the frame handler. The buffer utilizes a two-port RAM, with separate input and output ports and independent pointers for incoming and outgoing SPE data. The pass-through logic also contains a mechanism 80 for inserting a “fill byte” entry, and a broadcast bit for each of the 16 data ports. In standard mode, the fill byte is placed into empty bytes in the SPE; in broadcast mode, the original byte is retransmitted.

The broadcast bit is used in connection with multi-drop, distributed communications. In a communications network having a ring topology, it is often necessary to distribute the same information to multiple recipients on the network. This is typically done in a point-to-point fashion, wherein each recipient (i.e., drop point) removes the desired information from a received frame before relaying it to the next drop point on the network. When the frame is returned to the original sender, the information is reinserted into the next frame to be transmitted, so that another intended recipient could access it. A more efficient method of distributing information to multiple recipients is broadcasting. A broadcast drop point copies, rather than removes, the information before re-transmitting the content of the SPE(s). The next intended recipient can then get the information without the original sender having to resend it. After the broadcast SPE has traversed the ring, it is returned to the original or rebroadcasting sender, who then removes the information.

A diagnostic mode bit is implemented in the pass-through hardware, which allows the frame handler to send an error notification to a processor if an attempt is made to write to a byte that doesn't contain the fill byte value. The pass-through logic also includes an X⁴³+1 scrambler/descrambler, similar to those in the payload port queues. All the information in the STS-n frame is scrambled for transmission and de-scrambled for reception, except, per SONET specifications, for the A₁ and A₂ bytes of the manifest. Encoder circuitry combines the clock and data into the bit stream sent to the laser transmitter or photodiode receiver. A variety of bit stream encoding formats can be used, including standard SONET NRZ encoding, 8b/10b encoding, NRZ with address marker, 64/66 encoding, and/or 8b/10b with address marker.

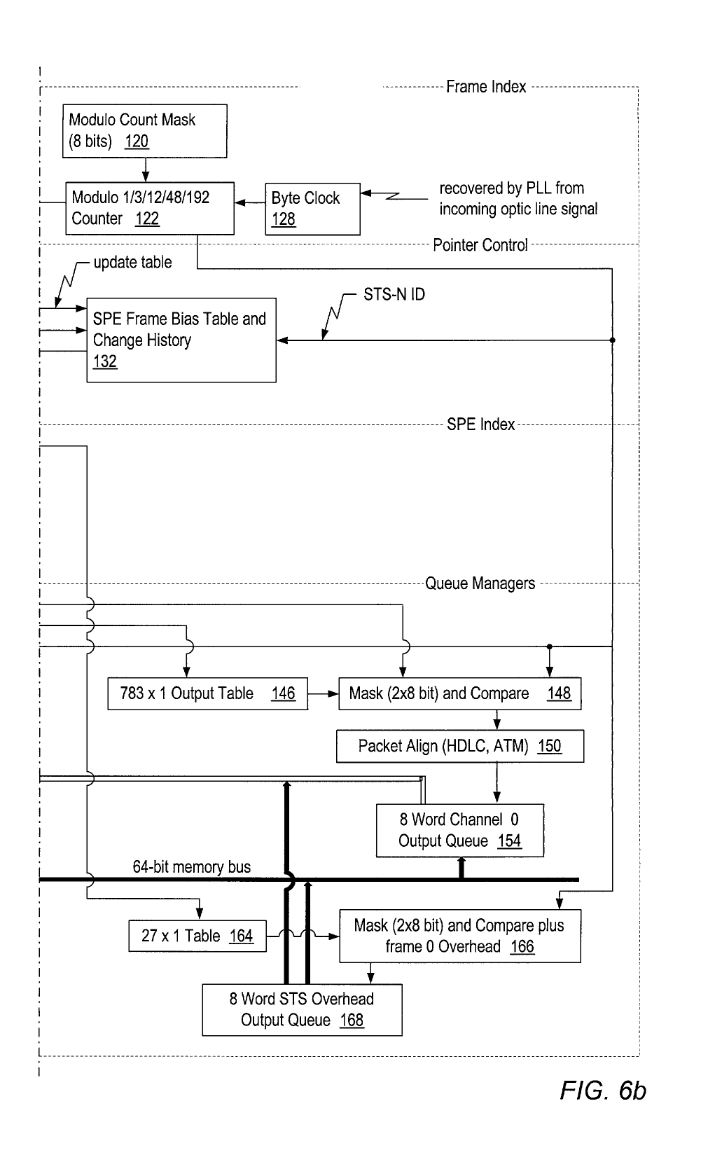

The output section of the frame handler, shown in FIG. 6, is similar to the input section. Modulo-count mask 120 programs the modulo-1/2/12/48/192 counter 122 for the current STS-n frame size. Modulo-90 124 and modulo-9 126 counters indicate the column and row of the current byte, as in the input section. Byte clock 128 drives the counters at a frequency derived from the incoming data stream. H₁H₂ pointer processor 130 maintains the offset to the SPE within the current STS-1 frame. The offset is stored in SPE frame bias table and change history 132. This table keeps track of the SPE bias in outgoing STS-n frames, and is the counterpart to the SPE frame bias table 60 in the input section of the frame handler. The two tables may be individually or jointly implemented using a two-port RAM.

A modulo-783 counter 134 and modulo-783 subtractor 136 convert the byte location within the STS-n SPE to the equivalent STS-1 location. 783-bit output tables 140 and 146, and 16-bit mask and compare words 142 and 148, perform the same function as their counterparts (discussed above) in the input section of the frame handler. Packet align 144 and 150 are used by the controlling program to delete fill bytes that were originally inserted in the incoming data files, typically in byte stream to word blocks conversion, or in other operations done by protocols such as ATM or HDLC that deposited the ADD data in main memory. For example, specific ATM 53 byte packets are stored in 7 64-bit words (56 bytes per packet); this section will remove the last three fill bytes before transmission. 8-word output capture queues 152 and 154 queue data from the 64-bit memory bus before transmission. Similarly, 27-bit table 164, 16-bit mask and compare word 166, and 8-word overhead output queue 168 format the manifest before transmitting the STS-n frame. SPE payload pass-through logic 160 performs rate matching and buffering, and input clock to system clock byte hand over from the frame handler input section. The pass-through logic 160 and “fill byte” entry insertion mechanism 162 for the output section function similarly to their counterparts in the frame handler input section, discussed above.

The present system and method exploit novel architectural features to achieve performance and cost advantages over conventional frame handlers. Among these, is the ability to operate in non-blocking mode. As explained above, a traditional frame handler must capture the entire incoming STS-n frame, before parsing and re-transmitting it. Since the STS-n frame rate is 8 KHz, a delay of 125 μs occurs at each blocking node through which the frame passes. In a large network, with many nodes, the cumulative delay may be intolerable. Furthermore, the need to buffer an entire STS-n frame in memory (155,520 bytes, for STS-192) means that traditional frame handlers require large amounts of high-speed RAM, which tends to make them expensive. In contrast, a frame handler embodying the system and methods disclosed herein parses the STS-n frame “on the fly”—i.e., before the entire frame has been received by the frame handler. Consequently, the latency is much lower than for a conventional frame handler, reducing cumulative delay effects. A further benefit of the present system and method is the avoidance of extensive high-speed memory. This lowers the cost of the frame handler, compared to a conventional approach.

A preferred embodiment of the system and method disclosed herein is a low-cost high-performance frame handler, suitable for PC-based network applications. In such an embodiment, the frame handler would be integrated into the Network Processing Unit (NPU) a communication protocol processing chip and/or into a network interface card (NIC) installed within a network server, a workstation, or desktop computer. The ability of the frame handler to deal with various communications protocols, including embedded asynchronous protocols (such as ATM), recommends it for use in inexpensive network interface hardware, allowing individual PC users to access high-bandwidth voice, video, and data communications.

It will be appreciated by those skilled in the art having the benefit of this disclosure that this invention is believed to present a system and method for interfacing a SONET communications network to a computer processor and/or to a communication switch node. Further modifications and alternative embodiments of various aspects of the invention will be apparent to those skilled in the art in view of this description. Such details as the number and depth of the data queues as described herein are exemplary of a particular embodiment, and may be altered in other embodiments. It is intended that the following claims be interpreted to embrace all such modifications and changes and, accordingly, the specification and drawings are to be regarded in an illustrative rather than a restrictive sense.

What is claimed is:

1. A communications interface between an optical network and a computer processor or a communication switch, said interface is adapted to synchronously receive and transmit a serial data stream, said communications interface comprising:
a first queue manager segment adapted to remove a first portion of the data from a frame of the received data stream and transfer the removed data to the computer processor;
a second queue manager segment adapted to transfer data from the computer processor into a frame of the transmitted data stream;
a pass-through buffer segment that transfers a second portion of the received frame to the transmitted frame, absent transferring the received frame to the computer processor;
a first frame index adapted to compute a unique physical address within the received frame of a byte in the received data stream;
a second frame index adapted to compute a unique physical address within the transmitted frame of a byte in the transmitted data stream;
first pointer control logic adapted to maintain a pointer to a payload portion of the received frame;
second pointer control logic adapted to maintain a pointer to a payload portion of the transmitted frame;
a first index adapted to compute a unique logical address for a byte within the payload portion of the received frame; and
a second index adapted to compute a unique logical address for a byte within the payload portion of the transmitted frame.

2. The communications interface as recited in claim 1, which may contain one or more scrambler/de-scramblers adapted to operate in byte-parallel mode.

3. The communications interface as recited in claim 1, wherein the first pointer control logic further comprises a table containing an offset to the start of one or more payloads within the received frame, and the second pointer control logic further comprises a table containing an offset to the start of one or more payloads within the transmitted frame.

4. The communications interface as recited in claim 3, wherein the table of the first control logic and the table of the second control logic each comprise a two-port random access memory.

5. The communications interface as recited in claim 1, wherein each queue manager further comprises a capture table containing a plurality of bits, such that each bit in the capture table of the first queue manager corresponds to a desired byte within the payload portion of the received frame, and each bit in the capture table of the second queue manager corresponds to a desired byte within the payload portion of the transmitted frame.

6. The communications interface as recited in claim 1, wherein each of the first and second queue managers contains an overhead capture queue, such that the overhead capture queue of the first queue manager is adapted to transfer data from the computer processor into the manifest portion of the transmitted frame, and the overhead capture queue of the second queue manager is adapted to remove data from the manifest portion of the received frame and transfer it to the computer processor.

7. The communications interface as recited in claim 2, wherein each of the first and second queue managers further comprises a plurality of data capture queues, for each of a plurality of lower-rate signals mapped into a payload within the transmitted and received frames.

8. The communications interface as recited in claim 1, wherein the transmitted and received frames comprise frames transmitted from or forwarded to a synchronous optical network (SONET) having differing transfer rates.

9. The communications interface as recited in claim 1, wherein the first pointer control logic further comprises first, second and third modulo counters, adapted to compute a frame number, row and column of each byte in the received data stream.

10. The communications interface as recited in claim 1, wherein the first and second queue managers each comprise a data port queue, such that each queue manager is adapted to respond to a set port instruction by configuring its data port queue according to parameters contained in the set port instruction.

11. The communications interface as recited in claim 10, wherein the first queue manager is adapted to respond to a broadcast bit in the set port instruction by copying, rather than removing, data from the received frame to the computer processor, and including said data in the transmitted frame.

12. The communications interface as recited in claim 1, wherein the interface is implemented as an integrated circuit.

13. A method for interfacing an optical communications network to a computer processor, comprising:
synchronously receiving a frame of serialized data from the network as an incoming data stream;
removing at least some of the data from the received frame and transferring the removed data to the computer processor;
transferring data from the computer processor to a transmitted frame; and
sending the transmitted frame as an outgoing data stream, such that the first byte of the outgoing data stream is adapted to be sent before the last byte of the incoming data stream has been received.

14. The method as recited in claim 13, further comprising queuing the incoming data stream in an input capture queue, and queuing the outgoing data stream in an output capture queue.

15. The method as recited in claim 13, further comprising scrambling the incoming data and de-scrambling the outgoing data, using a scrambler/de-scrambler circuit adapted to operate in byte-parallel mode.

16. The method as recited in claim 13, further comprising using first and second tables to record the offset to the start of one or more payload portions in the received and transmitted frames, respectively.

17. The method as recited in claim 13, further comprising using a frame index to record the physical address with respect to the received frame of a byte within the incoming serial data stream.

18. The method as recited in claim 13, further comprising using an index to record the logical address with respect to the payload portion of the received frame of a byte within the incoming byte data stream.

19. The method as recited in claim 16, further comprising implementing the first and second tables as two-port random access memory devices.

20. The method as recited in claim 14, further comprising associating a capture table with each capture queue, wherein the capture table comprises a plurality of bits, such that each bit corresponds to a desired byte within the payload portion of the received and transmitted frames.

21. The method as recited in claim 13, further comprising using a first overhead capture queue adapted to transfer data from the manifest portion of the received frame to the computer processor.

22. The method as recited in claim 13, further comprising using a second overhead capture queue adapted to transfer data from the computer processor to the manifest portion of the transmitted frame.

23. The method as recited in claim 14, further comprising using a plurality of data capture queues, for each of a plurality of lower-rate signals mapped into a payload within the received frame.

24. The method as recited in claim 14, further comprising using a plurality of data transmit queues, for each of a plurality of lower-rate signals mapped into a payload within the transmitted frame.

25. The method as recited in claim 13, wherein a frame comprises a data structure adapted for transmission over a synchronous optical network (SONET) having differing transfer rates.

26. The method as recited in claim 13, further comprising using first, second and third modulo counters adapted to compute the frame number, row and column of each byte in the incoming serial data stream.

27. The method as recited in claim 14, further comprising using a set port instruction to configure the input capture queue and output capture queue.

28. The method as recited in claim 14, further comprising using a broadcast bit in the set port instruction to direct the input capture queue to copy, rather than remove, data from the received frame to the computer processor, and including said data in the transmitted frame.

29. The method as recited in claim 13, further comprising using a changeable “fill byte” to replace data removed from the received frame, before transferring the data to the transmitted frame.
